(19) United States
(12) Patent Application Publication
(10) Pub. No.: US 2006/0181882 A1
(43) Pub. Date: Aug. 17, 2006

(54) Highly reflective lighting fixture visor that doubles as glare shield

(75) Inventors: Myron K. Gordin, Oskaloosa, IA (US); Timothy J. Boyle, Oskaloosa, IA (US)

Correspondence Address: MCKEE, VOORHEES & SEASE, P.L.C., 801 GRAND AVENUE, SUITE 3200, DES MOINES, IA, 50309-2721, US

(73) Assignee: MUSCO CORPORATION, Oskaloosa, IA (US)

(21) Appl. No.: 11/334,165

(22) Filed: Jan. 18, 2006

Related U.S. Application Data
(60) Provisional application No. 60/644,517, filed on Jan. 18, 2005.
(60) Provisional application No. 60/644,687, filed on Jan. 18, 2005.
(60) Provisional application No. 60/644,639, filed on Jan. 18, 2005.
(60) Provisional application No. 60/644,536, filed on Jan. 18, 2005.
(60) Provisional application No. 60/644,747, filed on Jan. 18, 2005.
(60) Provisional application No. 60/644,534, filed on Jan. 18, 2005.
(60) Provisional application No. 60/644,720, filed on Jan. 18, 2005.
(60) Provisional application No. 60/644,688, filed on Jan. 18, 2005.
(60) Provisional application No. 60/644,636, filed on Jan. 18, 2005.
(60) Provisional application No. 60/644,517, filed on Jan. 18, 2005.
(60) Provisional application No. 60/644,609, filed on Jan. 18, 2005.
(60) Provisional application No. 60/644,516, filed on Jan. 18, 2005.
(60) Provisional application No. 60/644,546, filed on Jan. 18, 2005.
(60) Provisional application No. 60/644,547, filed on Jan. 18, 2005.
(60) Provisional application No. 60/644,638, filed on Jan. 18, 2005.
(60) Provisional application No. 60/644,537, filed on Jan. 18, 2005.
(60) Provisional application No. 60/644,637, filed on Jan. 18, 2005.
(60) Provisional application No. 60/644,719, filed on Jan. 18, 2005.
(60) Provisional application No. 60/644,784, filed on Jan. 18, 2005.

(51) Int. Cl. F21V 7/00

(52) U.S. Cl. 362/350

(57) ABSTRACT

An apparatus, method, and system of high intensity lighting for a target area. One aspect of the invention includes utilizing an extension structure or visor externally of the lighting fixture. The shape, size, and reflecting properties of the visor are designed to provide both glare and spill control and no material diminishment of light to the target area. Preferably a very high reflectance reflecting surface is included on at least a portion of the visor to increase usable light to the target area.

### CROSS REFERENCE TO RELATED APPLICATIONS

This application claims priority under 35 U.S.C. § 119 of a provisional application U.S. Ser. No. 60/644,517 filed Jan. 18, 2005, herein incorporated by reference in its entirety. This application is also a non-provisional of the following provisional U.S. applications, all filed Jan. 18, 2005: U.S. Ser. No. 60/644,639; U.S. Ser. No. 60/644,536; U.S. Ser. No. 60/644,747; U.S. Ser. No. 60/644,534; U.S. Ser. No. 60/644,720; U.S. Ser. No. 60/644,688; U.S. Ser. No. 60/644,636; U.S. Ser. No. 60/644,609; U.S. Ser. No. 60/644,516; U.S. Ser. No. 60/644,546; U.S. Ser. No. 60/644,547; U.S. Ser. No. 60/644,638; U.S. Ser. No. 60/644,537; U.S. Ser. No. 60/644,637; U.S. Ser. No. 60/644,719; U.S. Ser. No. 60/644,784; U.S. Ser. No. 60/644,687, each of which is herein incorporated by reference in its entirety.

### INCORPORATION BY REFERENCE

The contents of the following U.S. patents are incorporated by reference by their entirety: U.S. Pat. Nos. 4,816,974; 4,947,303; 5,161,883; 5,600,537; 5,816,691; 5,856,721; 6,036,338.

### I. BACKGROUND OF THE INVENTION

A. Field of the Invention

The present invention relates to lighting fixtures that produce high intensity, controlled, and concentrated light beams for use at relatively distant targets. In particular, the invention relates to such lighting fixtures, their methods of use, and their use in systems where a plurality of such fixtures are used in combination, usually elevated on poles, to compositely illuminate a target area energy-efficiently, with reduced glare and spill light, and with the capability to lower capital and/or operating costs. One primary example is illumination of a sports field.

B. Problems in the Art

This general configuration of sports lighting fixtures 2 has remained relatively constant over many years because it is a relatively economical and durable design. In recent times, sports lighting has also had to deal with the issue of glare and spill light. For example, if light travels outside the area of the sports field, it can spill onto residential houses near the sports field. Also, the high intensity of the lamps can cause glare to such homeowner or create safety issues for drivers on nearby roads. Some communities have enacted laws regulating how much glare or spill light can be caused by sports lighting or other wide-area outdoors lighting. While a number of attempted remedies exist, many result in blocking, absorbing, or otherwise reducing the amount of light going to the field. This can not only increase cost of the lighting system because of the glare or spill control measures, but in some cases requires additional fixtures to meet minimum light quantity and uniformity specifications. More cost might therefore be incurred, to make up for the light lost in glare and spill control measures. In some cases, it can even require more costly and/or additional poles to support the additional fixtures.

Therefore, competing interests and issues provide challenges to sports lighting designers. Some of the interests and issues can be at odds with one another. For example, the need always remains for more economical sports lighting. On the other hand, glare and spill control can actually add cost and/or reduce the amount of light available to light the field. Designers have to balance a number of factors, for example, cost, durability, size, weight, wind load, longevity, and maintenance issues, to name a few. Attempts to advance the art have mainly focused on discrete aspects of sports lighting. For example, computerized design of lighting systems tends to minimize hardware costs and system installation costs but uses conventional lamp and fixture technology, with their weaknesses. Also, larger lumen output lamps produce more light, but are used with conventional fixture technology. A need, therefore, still exists for advancement in the art of sports lighting.

### II. SUMMARY OF THE INVENTION

One issue addressed by the present invention is the efficient production of light. This has several connotations. One is reducing the amount of energy needed to achieve a certain light level and uniformity at a target. However, another can be increasing the amount of useful light for the target from a given amount of energy.

The present invention also addresses other environmental issues. Many lighting applications call for a certain amount or intensity of light at and above a target space, but also with a certain level of uniformity across the target space. In the example discussed above, lighting fixtures are elevated around the perimeter of the target space and their beams aimed to different locations to try to achieve the intensity and uniformity desired throughout the target space. It is difficult to achieve, especially at the margins of the target space, without some light falling outside the target space. Such spill and glare light can have environmental impact. It can cause “light pollution” of neighboring property. It can create safety issues, for example, by obscuring the vision of drivers or pedestrians on roads or paths around the lights. The present invention therefore addresses spill and glare light problems.

The present invention also provides the ability to select different configurations to meet different needs for a lighting application. For example, features of the lighting system can be selected to achieve lower capital costs for the lighting system. Features can be selected to lower operating costs. Features can be selected to reduce glare and spill light. Features can be selected to increase the quantity or quality of light at and above the target space and/or the performance of the system. The invention allows concentration on just one of the above-listed features or on combinations of them.

A. Objects, Features, or Advantages, of the Invention

It is therefore a principal object, feature, or advantage of the present invention to present a high intensity lighting fixture, its method of use, and its incorporation into a lighting system, which improves over or solves certain problems and deficiencies in the art.

Other objects, features, or advantages of the present invention include such a fixture, method, or system which can accomplish one or more of the following:

a) reduce energy use;

b) increase the amount of useable light at each fixture for a fixed amount of energy;

c) more effectively utilize the light produced at each fixture relative to a target area;

d) can reduce glare and spill light relative a target space or area;

e) can reduce wind drag or effective projected area (EPA) of individual fixtures or sets of fixtures, which can allow smaller and/or less expensive elevating structures (e.g. poles), which in turn can materially decrease the capital cost of a lighting system.

B. Exemplary Aspects of the Invention

In another aspect of the invention, an additional reflecting surface extends forwardly from the general surface of revolution of the main reflecting surface and is also made of high reflectivity material. As opposed to conventional visors which are used primarily to block light, this reflecting surface can function not only to block light that could be glare or spill light, but efficiently and in a highly controllable manner redirect the otherwise wasted light to the target area. The framework supporting the additional reflecting surface can be connected to the framework for the main reflecting surface in an integrated manner that also minimizes wind drag for the entire fixture.

Another aspect of the invention, an apparatus, method, and system are provided which materially reduce glare or spill light from one or a plurality of fixtures for a given application or target space.

These and other objects, features, advantages and aspects of the present invention will become more apparent with reference to the accompanying specification and claims.

### III. BRIEF DESCRIPTION OF THE DRAWINGS

FIGS. 1A-F shows a typical sports lighting system.

FIGS. 2A-E illustrates one type of arc tube that could be used with the invention.

FIGS. 3A and B illustrate a type of arc lamp, the arc tube of FIGS. 2A-E could be used with.

FIG. 4 is an exploded perspective view of one exemplary embodiment according to the invention.

FIGS. 5A and 5B are various views of the fixture of FIG. 4 with a first exemplary embodiment of a visor (sometimes referred to as the short visor) according to the present invention.

FIGS. 6A and 6B are similar to FIGS. 5A and 5B but with a second exemplary embodiment of a visor (sometimes referred to as the long visor) according to the present invention.

FIG. 7A is a side-by-side perspective view of the two visors of FIGS. 5A and 6A attached to the reflector frame and also showing examples of high reflectivity reflecting strips mounted on the underside of the visors.

FIG. 7B is a partial perspective view showing the left-most visor of FIG. 7A attached to a reflector frame.

FIGS. 8A and 8B are additional perspective views of the left-most reflector of FIG. 7A.

FIGS. 9A and 9B are additional perspective views of the right-most reflector of FIG. 7A.

FIGS. 10A and 11A-D are views of a visor reflective insert upper rail and lower rail respectively, mountable on the inside of a visor to which can be attached high reflectance reflective insert strips such as shown in FIGS. 7A-9A.

FIGS. 12A-D shows a visor transition clip securable to the inside of a visor for a transition between different sets of reflective inserts at different levels.

FIG. 13 is a plan view of a base visor attachable to the lens rim of FIG. 23A.

FIG. 14 is a plan view of a visor extension attachable to the base visor of FIG. 13 to form the short visor of FIG. 7A.

FIG. 15 is a plan view of an alternative visor extension connectable to the base visor of FIG. 13 to form the long visor FIGS. 9A.

FIGS. 16A-C illustrates one example of longer visor inserts.

FIGS. 17A-C is various views of a specially configured end reflective visor insert positionable at opposite lateral sides of a visor.

FIGS. 18A and 18B are alternative embodiments of a reflective visor insert.

FIGS. 19A-C are alternative embodiments of the opposite end reflective visor insert useable with the reflective inserts of FIG. 18A.

FIGS. 20A-C are views of a visor insert support for visor inserts of FIGS. 16A and 17A.

FIGS. 21A-C are views of a visor insert support useable with the reflective inserts of FIGS. 18A and 19A.

FIGS. 22A-C are views of a visor insert assembly alignment bracket.

FIGS. 23A-F is lens rims used with the fixture above.

FIGS. 24A-E, 25A and 26A-C illustrate parts of lens rim clips.

### IV. DETAILED DESCRIPTION OF EXEMPLARY EMBODIMENTS

A. Exemplary Apparatus

FIG. 4A shows the basic components of sports lighting fixture 10 in exploded form. FIGS. 5A and B show it in assembled perspective form. Fixture 10 has some similar general components to state-of-the-art sports lighting fixtures, but introduces some different structural components and concepts.

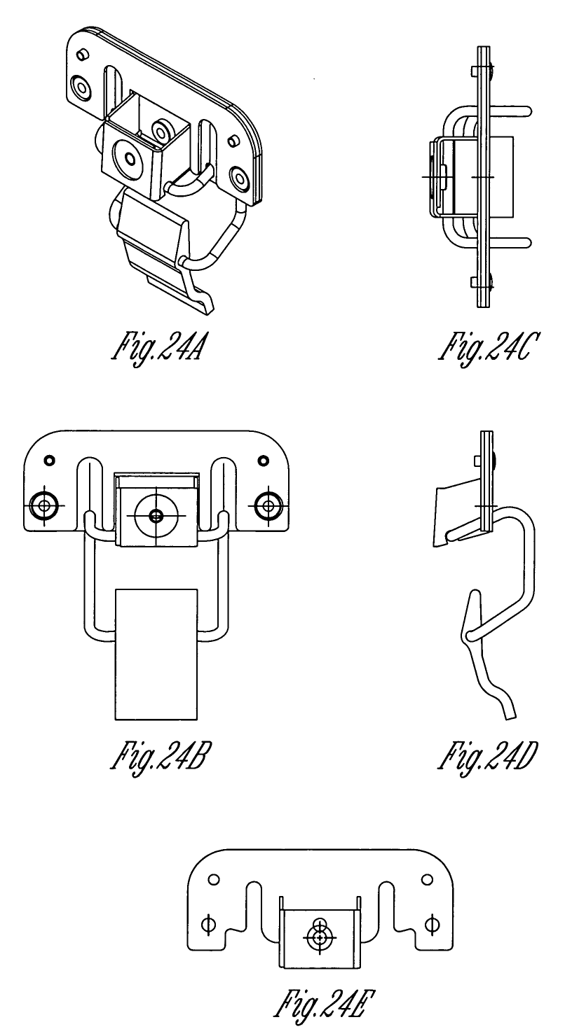

Reflector frame 30 (cast aluminum type 413) bolts to lamp cone 40. The frame (FIG. 23A) for glass lens 32 is removably latched to the front of reflector frame 30. Visor 70 is mountable to the lens frame and extends from the upper front of reflector frame 30 when in place. It includes high reflectivity strips on its interior 72.

As indicated by comparing FIG. 5A with FIG. 6A, visor 70 can take different shapes and forms. A first style of visor 70A (FIG. 5A) is shorter and does not extend forwardly and downwardly as much as second visor style 70B (FIG. 6A). Both have an identical base section that extends initially at a less converging angle from reflector frame 30. A distal extension section connects to the base section and angles back inwardly toward the central axis of reflector frame 30. The shorter visor 70A uses a shorter extension section than the longer visor 70B. Visor 70B is useful, for example, when fixture 10 is aimed at angles closer to horizontal. It would block and redirect more light that would otherwise go off the target area, as compared to visor 70A.

As indicated at FIG. 4, visor 70 is attachable to fixture 10. High total reflectivity material is mounted on its inner or downward-facing side 72. Essentially the exterior of visor 70 is a protective cover over the high reflectivity material it supports. FIGS. 5A, 6A and 7-9 illustrate two general forms visor 70 can take.

Either form of visor 70 actually is larger in size than many existing visors, and increases the overall size of fixture 10. However, their shape and configuration has been designed to actually decrease wind load by on the order of 40% over conventional fixtures. The length, shape, and edges of visors 70 are designed to improve the EPA of the whole fixture 10. They are cost effective with excellent reflection efficiency.

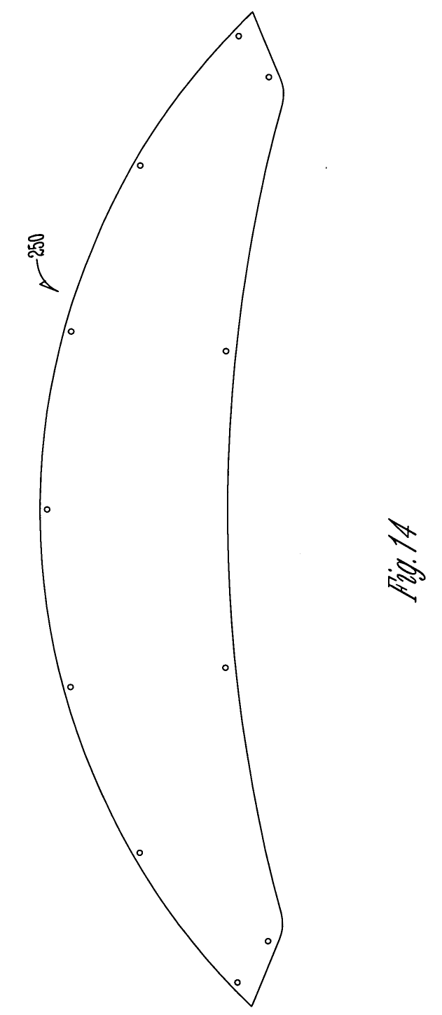

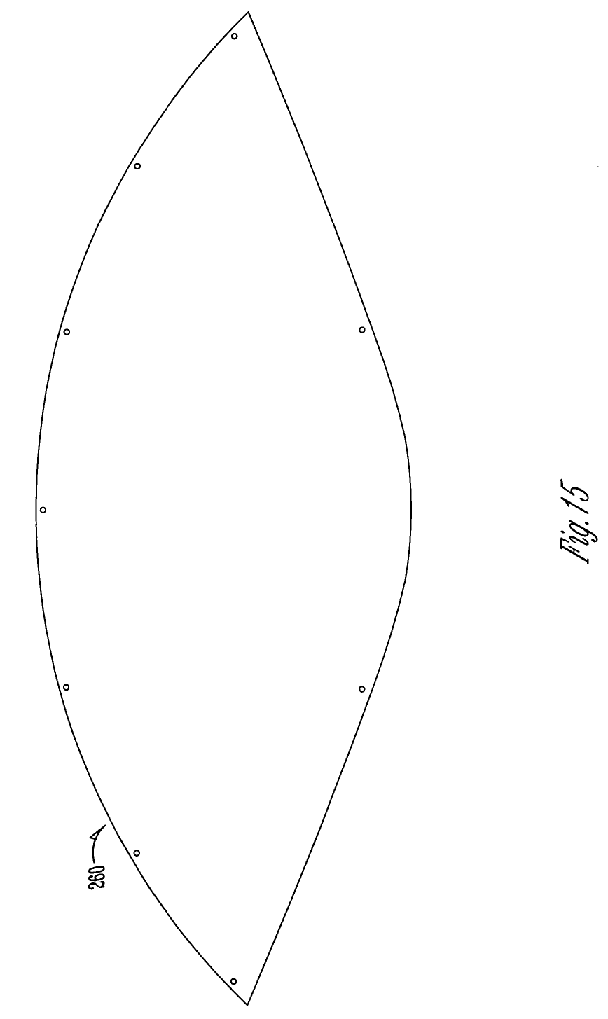

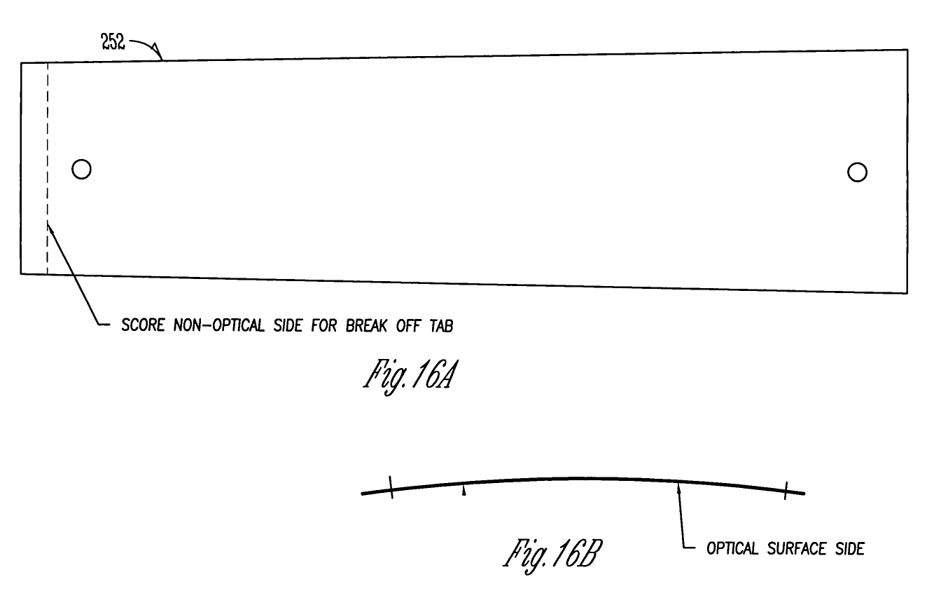

The two general forms for visor 70 are illustrated in the drawings (see, e.g., short visor 70A of FIG. 5A and long visor 70B of FIG. 6A). Both start with a base visor section 240 (FIG. 13) that is attached to lens rim 230 by rivets, bolts or other means. A second or outer visor section, either short visor section 250 (FIG. 14) or long visor section 260 (FIG. 15), is attached by rivets, bolts or otherwise to base visor 240.

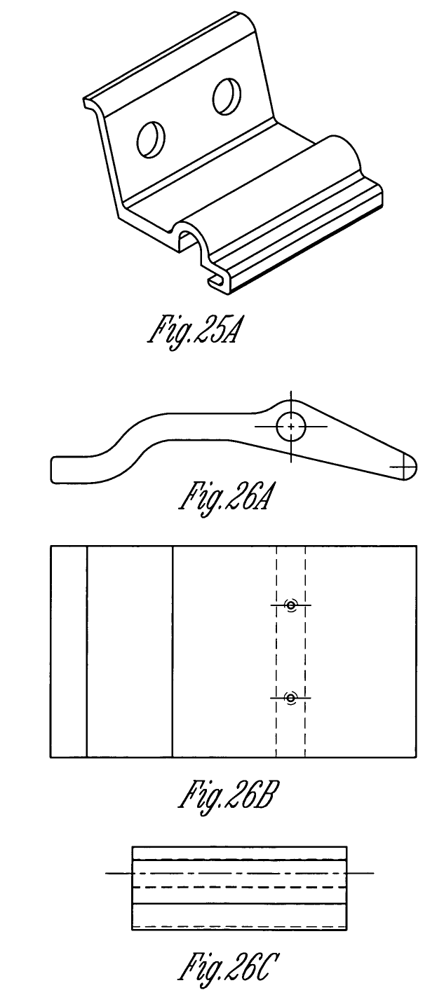

Base visor section 240 is attached to lens rim 230 (with glass lens 3 installed). FIGS. 24, 25, and 26 illustrate the specifics of the parts for lens rim clips 233 that can latch lens rim 230 to the reflector frame 30. Lens rim 230 (FIG. 23A) generally matches the perimeter opening to reflector frame 30. Base visor section 240 is welded or riveted into slot 232 of lens rim 230 and supported by arm 234. Slot 236 holds glass lens 3. Slot 238 allows connection to reflector frame 30. Lens gasket 231 cushions and seals glass lens 3 in slot 236.

A built-in extrusion on the outside of lens rim 230 provides a mounting flange for visor 70. Base visor section 240 is at an angle (20 degrees) to lens rim 230 and to reflector frame 30 when mounted on it. Latches 242 (see FIGS. 5 and 6 showing latches 242 in a latched state and FIGS. 24-26 for some of the pieces that make up a latch) allow secure but easy removal and reattachment of the lens 34/visor 70 combination to reflector frame 30.

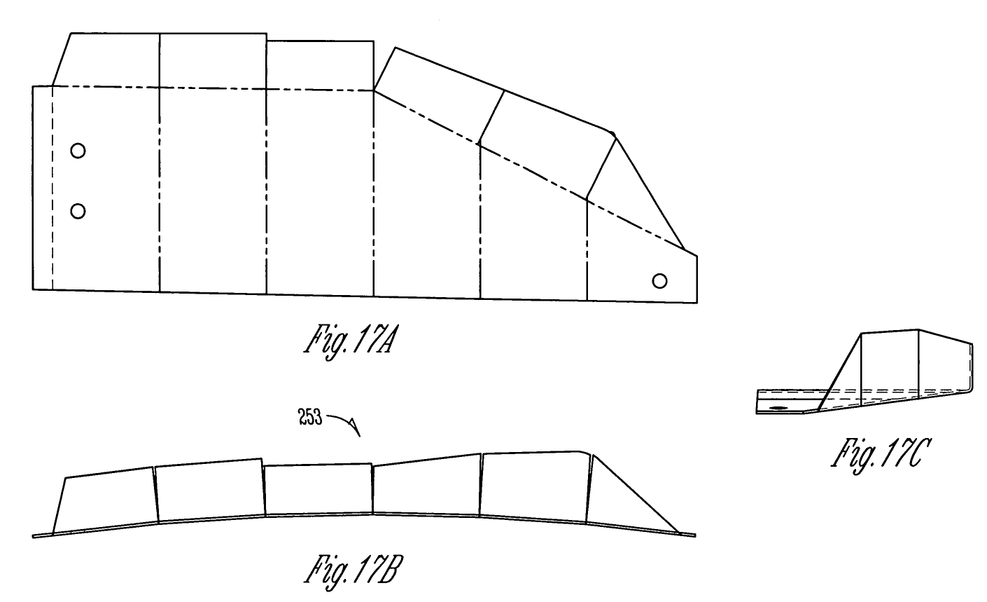

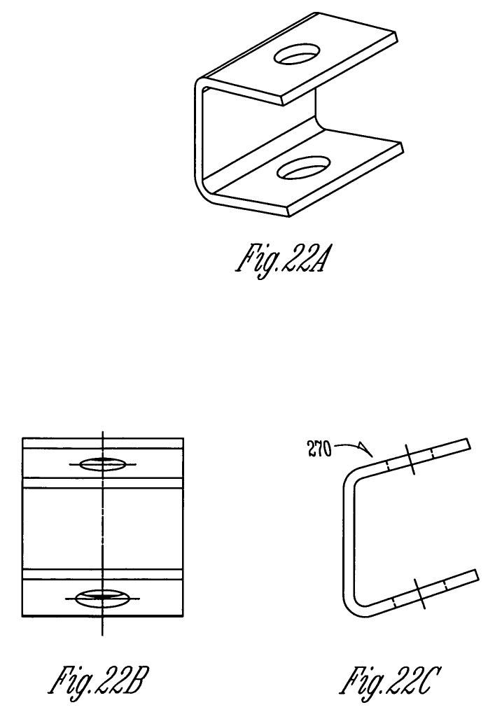

As can be seen in FIG. 8, a plurality of side-by-side, high reflectivity reflector inserts (e.g., reflective inserts 252 of FIG. 16A) are riveted or otherwise secured to the inside of base reflector 240 and attached reflector 250. Alternatively, upper and lower rails 254 and 256 can be attached to proximal and distal positions on the inside of visor combination 240/250, and the reflective visors installed into slots 255 and 257 respectively, and then riveted or bolted into place. One or more radial support brackets 258 (see FIGS. 20A-C), can be connected back to front of visor combination 240 and 250 to provide more rigidity for upper and lower visor reflective insert rails 254 and 256.

Reflective inserts 252 on visor 70 can be the same type of material as reflector inserts 120 for primary reflecting surface 32 described above. Alternatively, they can be flat reflective sheet portions with surface variations that create diffusion for a mix of light. For example, they could have facets or steps (e.g. peens or dots). They also could have low or no reflectivity areas that simply block or absorb light (e.g. painted flat black) (see Musco U.S. Pat. No. 6,036,338 for additional detail).

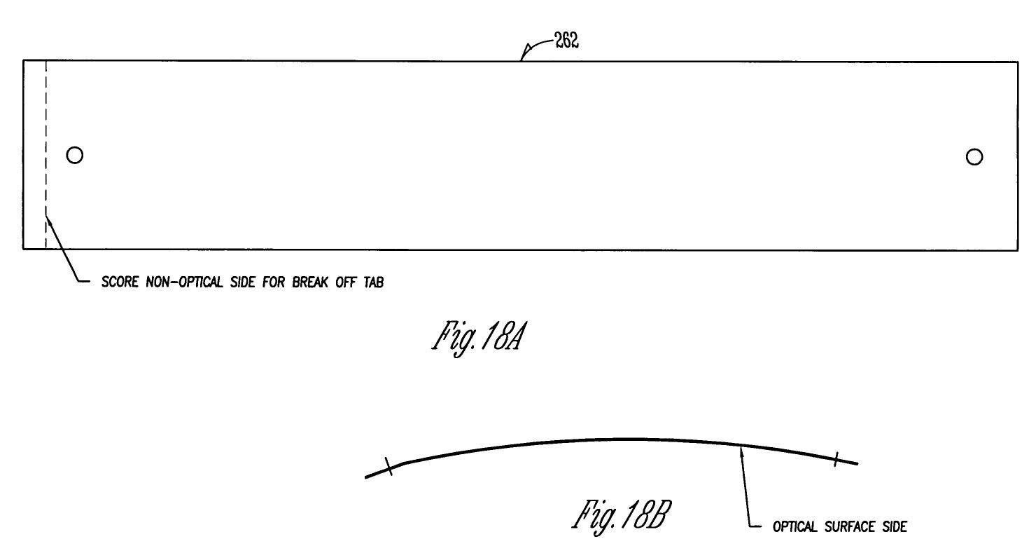

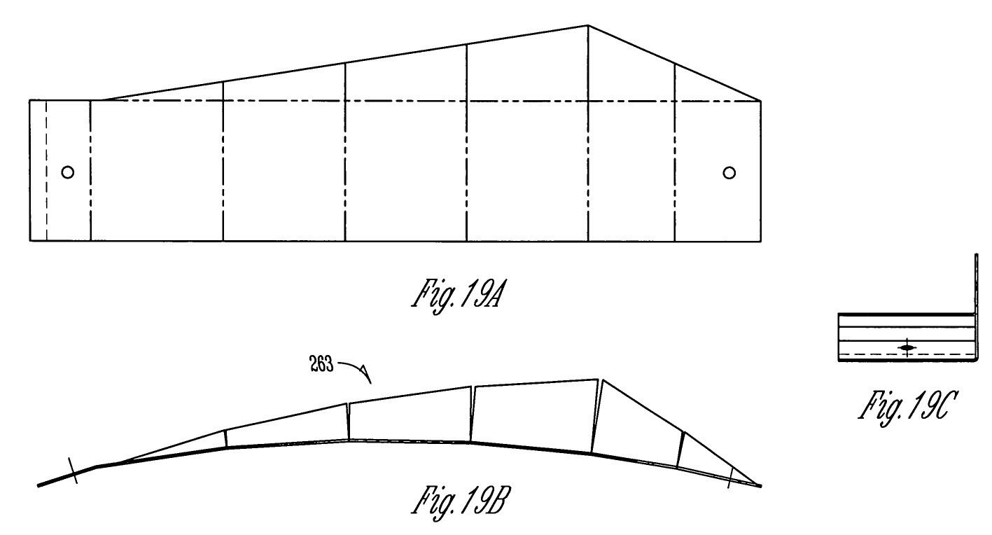

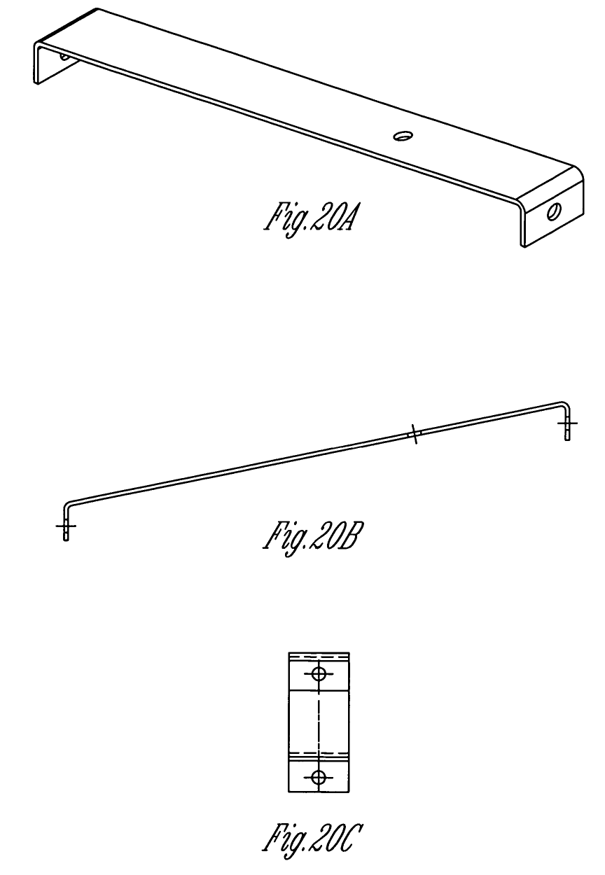

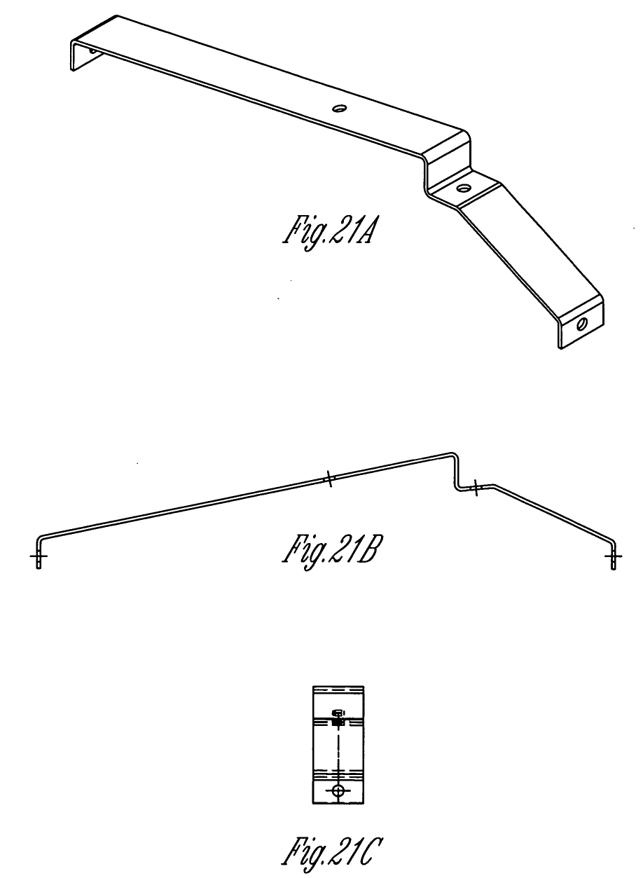

Specially shaped end reflective inserts 253 can be positioned at the lateral edges of opposite sides of visor 70 (see FIGS. 17A-C). End reflective inserts 262 can be placed on the underside of the longer visor combination 240/260 (see FIGS. 18A-B). End inserts 263 would be similar to end inserts 253 but configured for the shorter visor 250/260 (see FIGS. 19A-C).

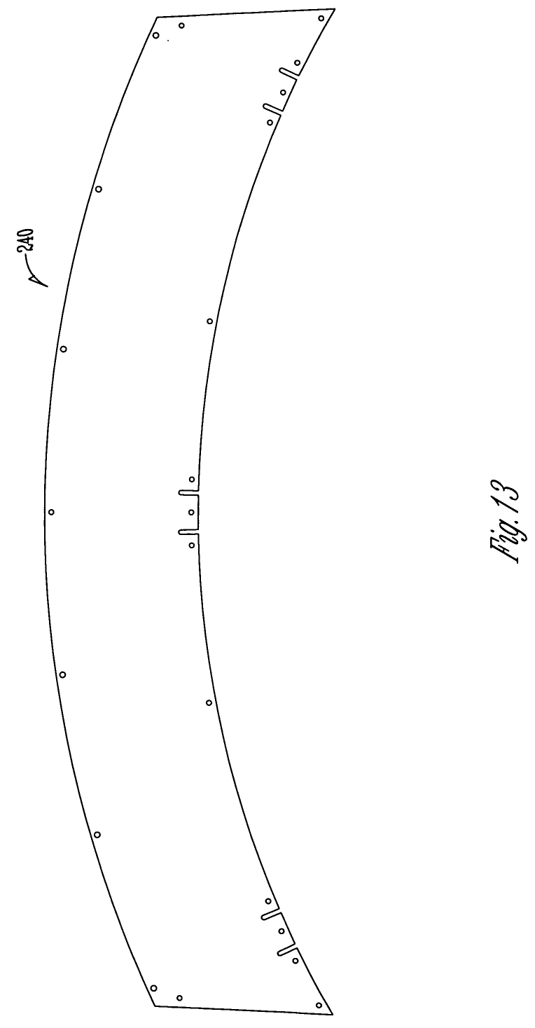

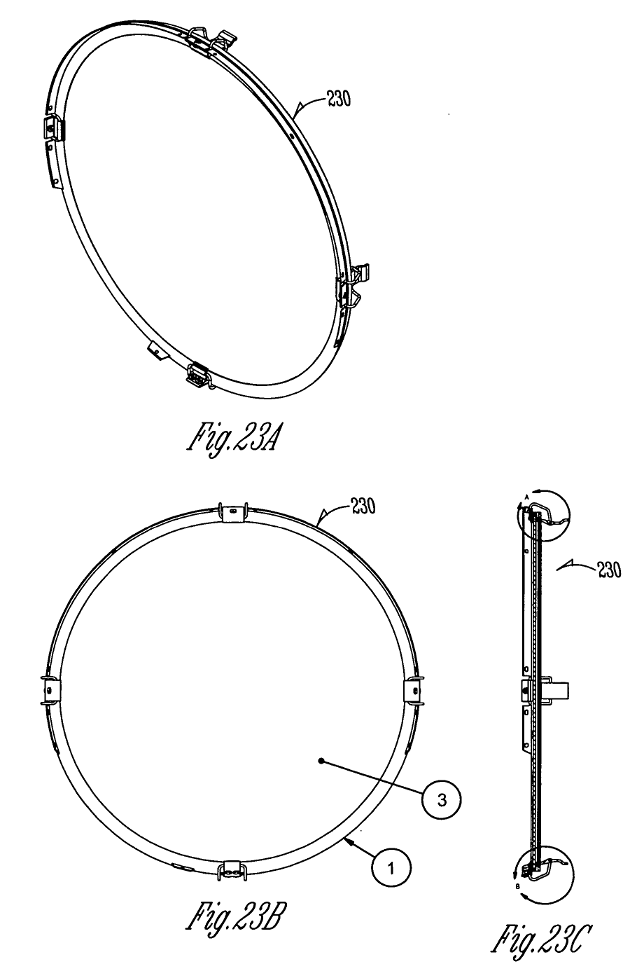

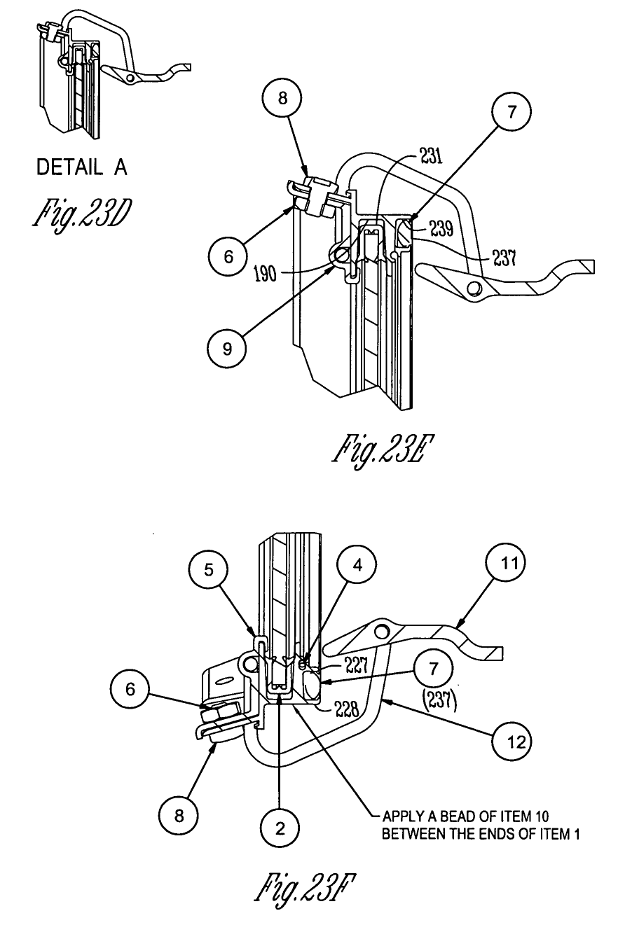

The reflective inserts can be directly attached to the underside of visor combination 240/260. Alternatively, they could be attached to appropriately configured upper and lower rails such as 254 and 256 (FIGS. 20-22) that are attached to the underside of reflector 70. In certain circumstances, there may be a transition between reflective inserts. FIG. 12 illustrates transition clip 264, and FIGS. 21A-C illustrate insert support bracket 268 that would be first attached to the underside of reflector 70 and then reflective inserts mounted to reflector 70.

The nature of the surface(s) of reflective inserts 252, 253, or 263 can be selected, mixed and matched, according to the type of manipulation of light that is desired. As can be seen in the figures, the reflective insert strips can be of different widths, lengths, and surface. As shown, some can be smooth and some can be pebbled or otherwise altered to be less spectacular or to diffuse light. The inserts can also be stepped along their longitudinal axis.

Visor 70 acts both to block and redirect light that otherwise likely would go off target. The high reflectivity material for the visor reflecting surface reduces light loss and thus provides more light to the target area, even over prior visors that have some reflectivity. It provides significant light gains compared to conventional visors that simply block or absorb most or all of the light that strike it.

It is furthermore to be understood that other variations of reflector 70 are possible. Examples are shown in Musco Corporation U.S. Pat. No. 5,211,473. Examples of these types of visors are available from Musco Corporation under various brand names including LEVEL 8™. They provide various degrees of glare and spill light control. They can be selectively added to fixture 10. Some of the variations shown in U.S. Pat. No. 5,211,473 are for substantial reduction of glare and spill light. Some include louvers across the visor. If used with visors 70 of this embodiment, the fixture 10 will still have good efficiency and not as big of light loss as with the type of fixtures disclosed in U.S. Pat. No. 5,211,473 (e.g. spun aluminum reflectors).Other variations are described and shown herein.

The shape of visor 70 is designed to achieve several functions. First, it supports the highly reflective inserts in a manner that controls spill and glare light. Second, it supports the reflective inserts in a manner which minimizes light loss, and can increase light to the target. Third, its shape minimizes the projected area of the visor and the fixture generally to produce a low coefficient of drag. Fourth, it accomplishes these functions in a relatively low cost but efficient way.

Even though the overall size of fixture 10 is larger than some conventional similar fixtures, the wind drag is reduced on the order of 40% or more. Spill and glare can be controlled with a visor 70, but also with other features disclosed herein, if used (e.g. lower initial output intensity, side shift, reflecting surfaces that highly control direction of light). This can allow cheaper poles to be utilized, which can significantly reduce overall capital cost of a lighting system. Less wind drag means the strength of the pole that elevates the fixtures can be less.

Visor 70 can be used even if glare and spill control is not an issue because of improved EPA of the fixture, which can reduce cost of poles. It has excellent efficiency and is relatively low cost. This is especially beneficial for outdoors sports lighting.

It will be appreciated that the invention can take many forms and embodiments. Variations obvious to those skilled in the art will be included within the invention. The scope of the invention is defined solely by the claims and not the specific examples herein.

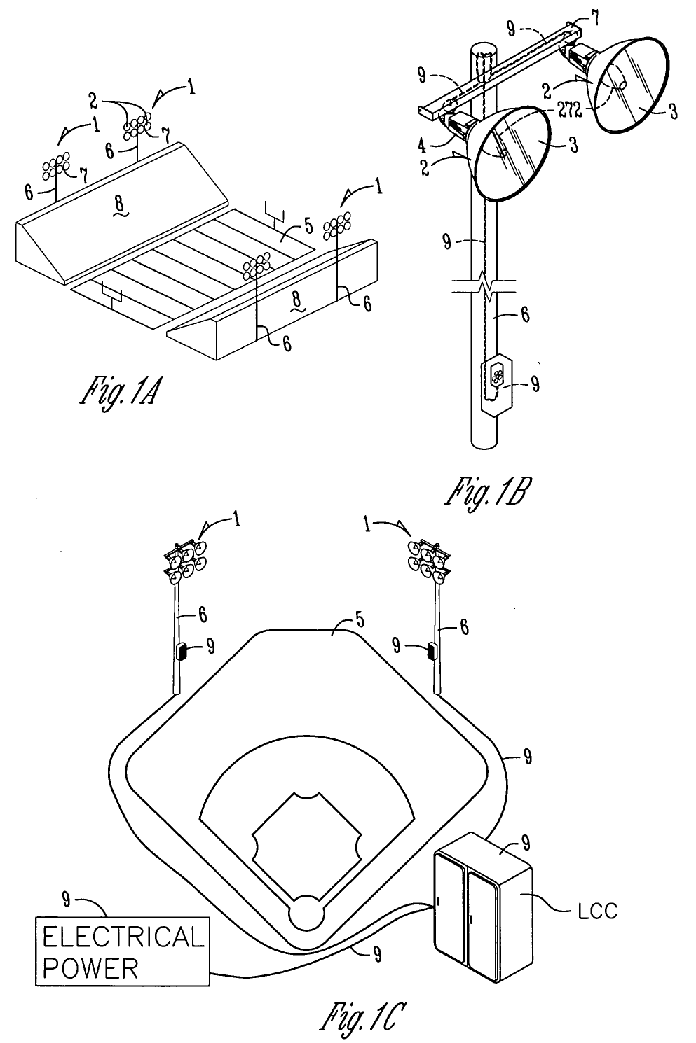

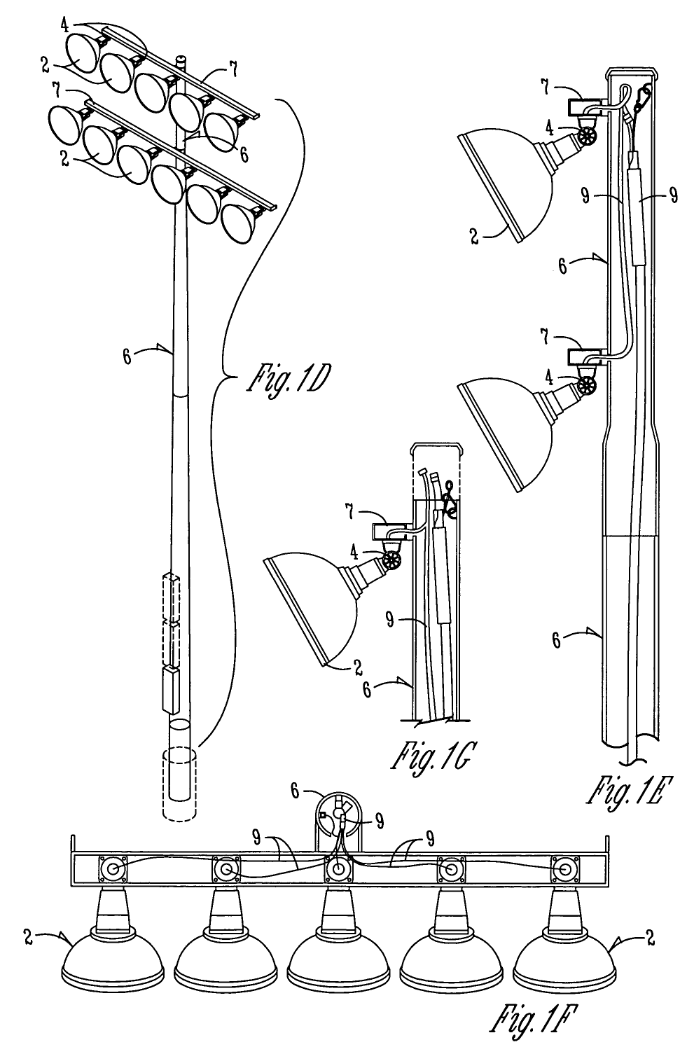

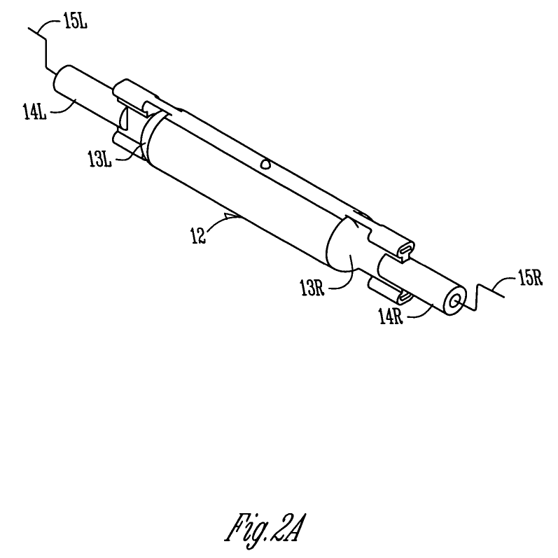

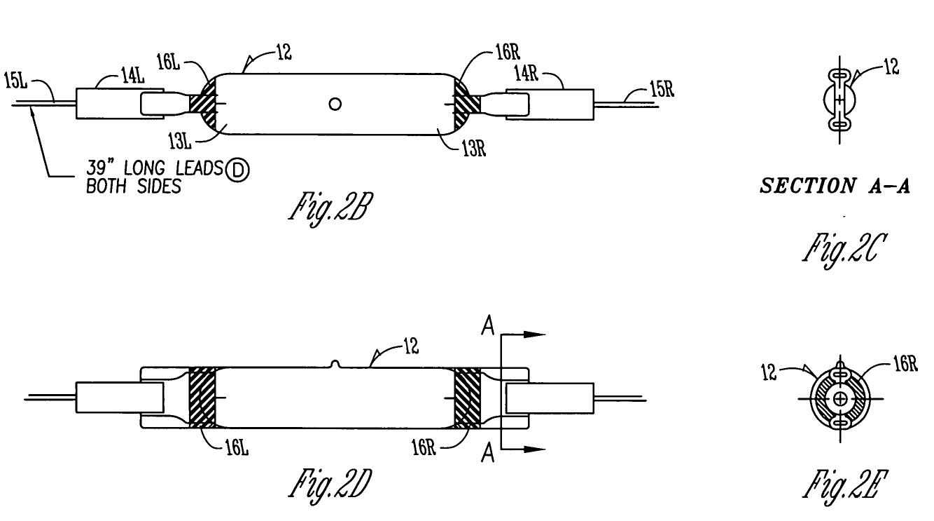

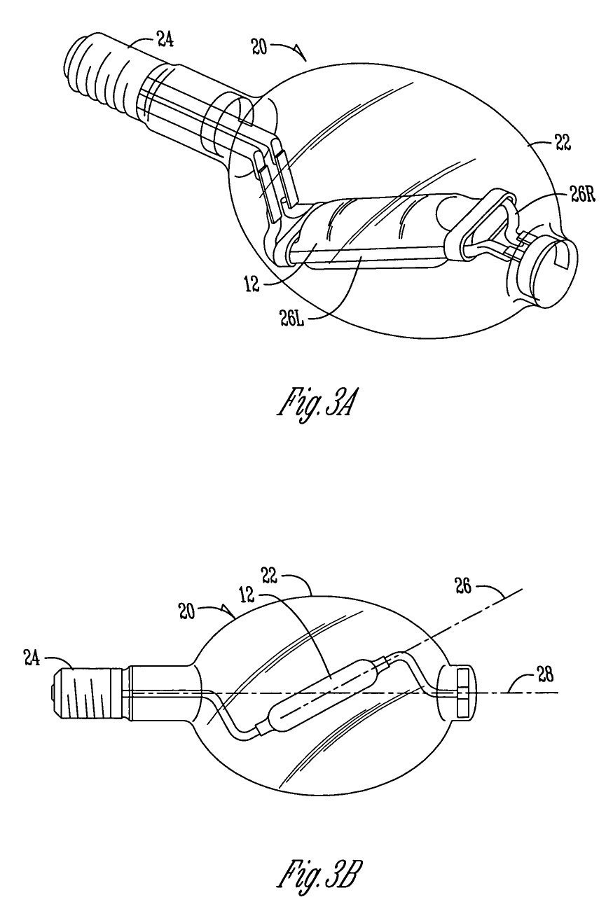

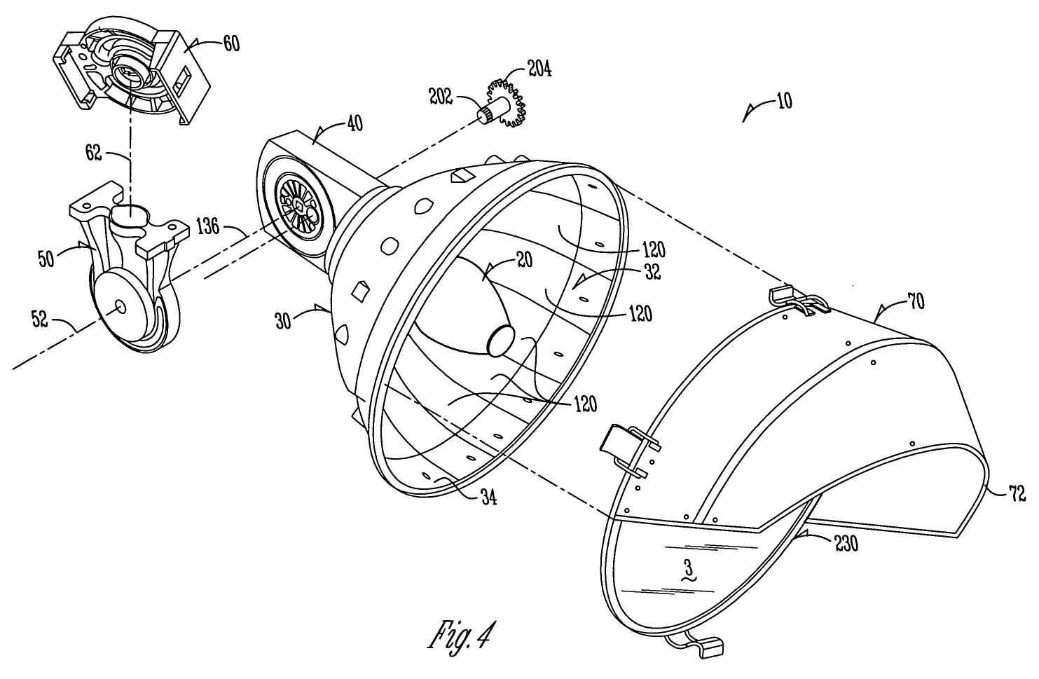

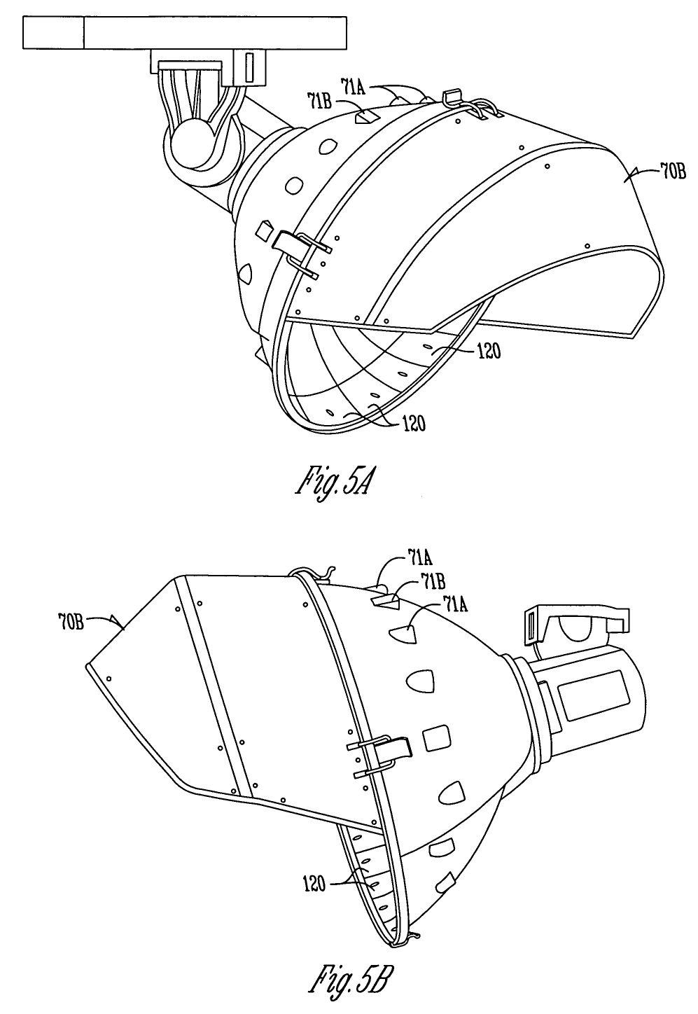

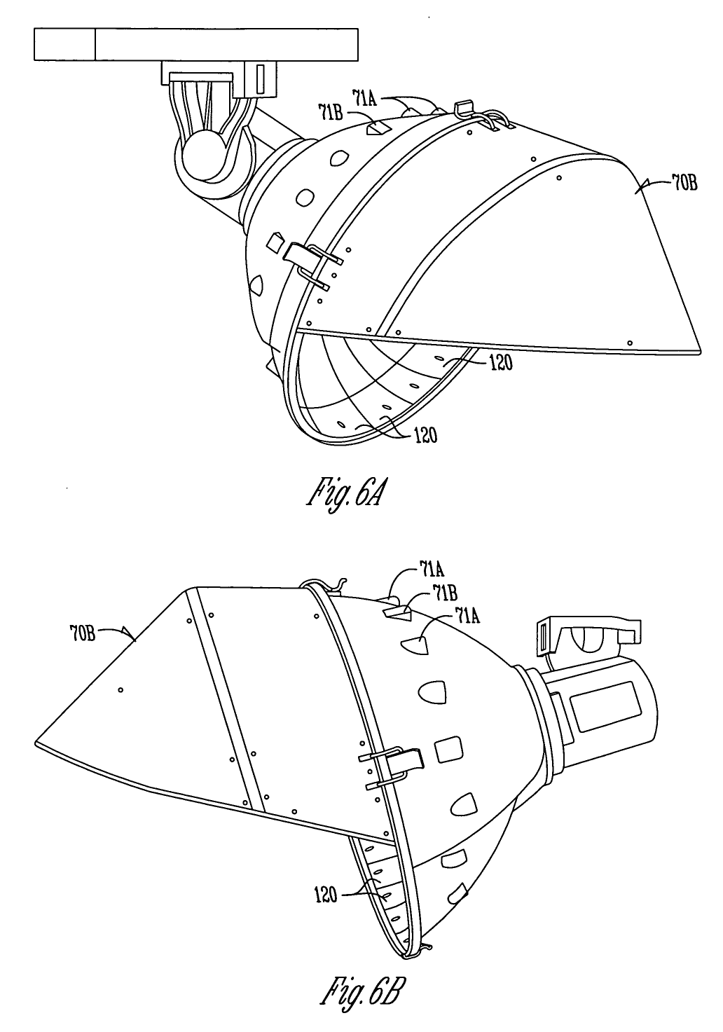

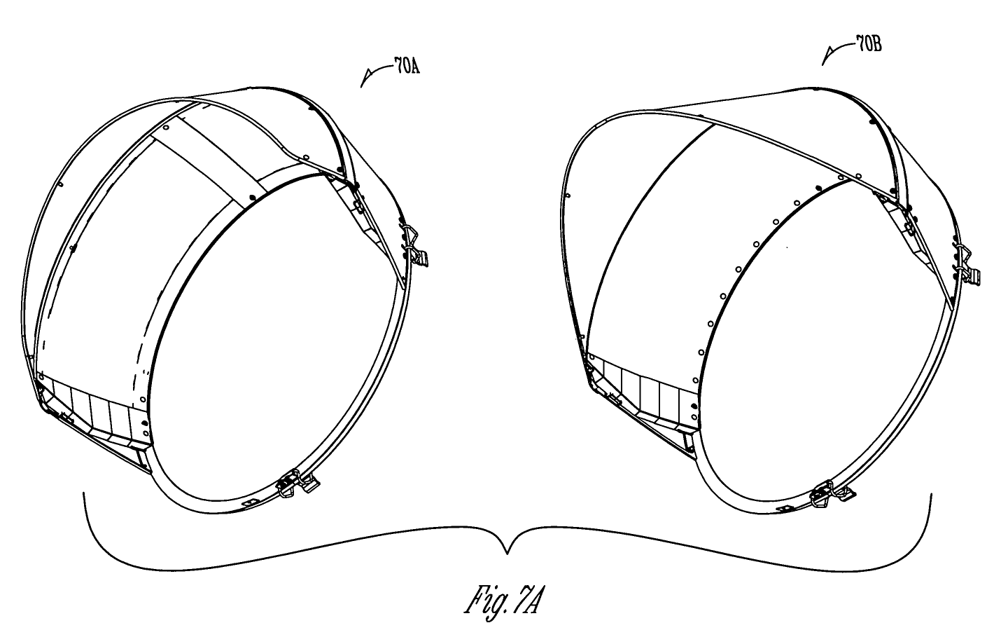

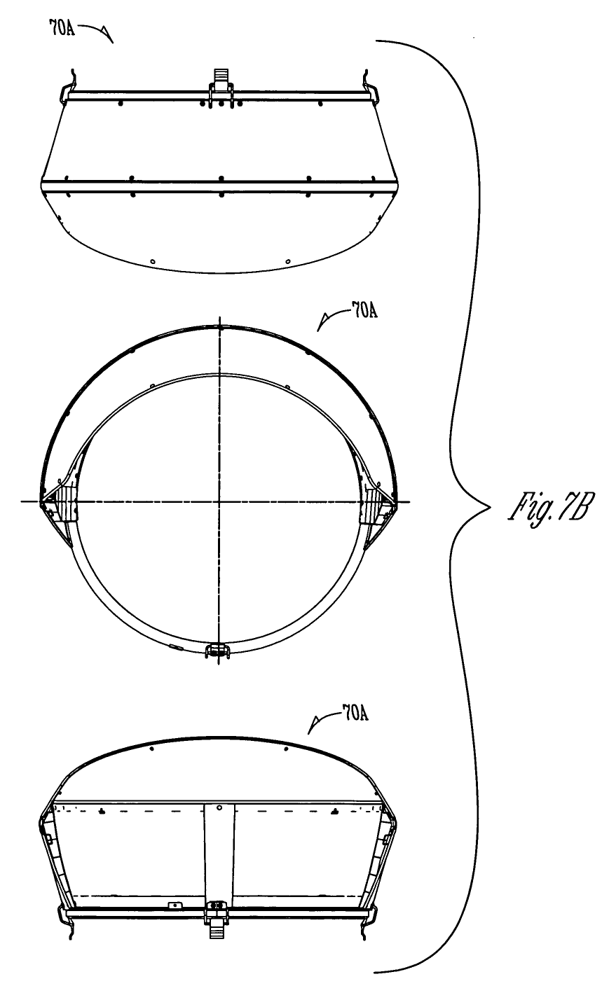

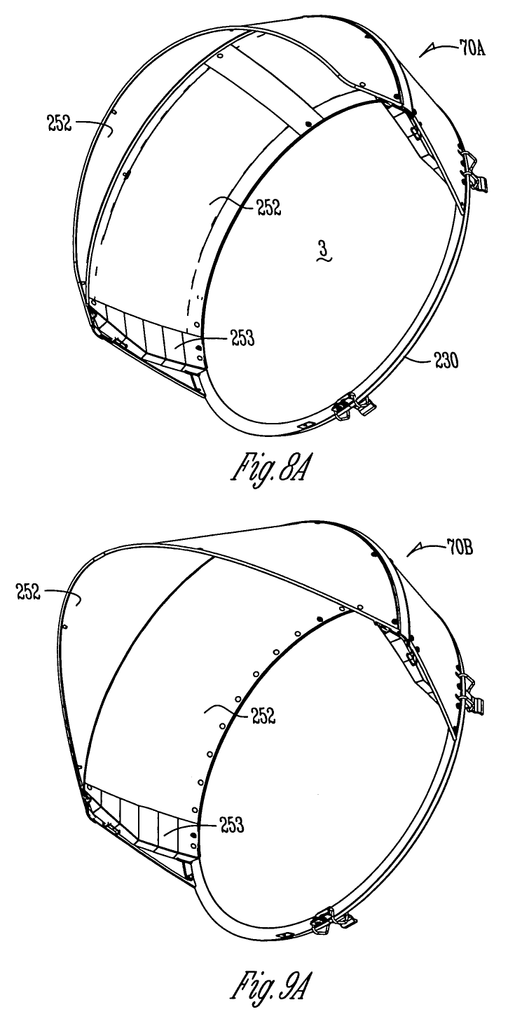

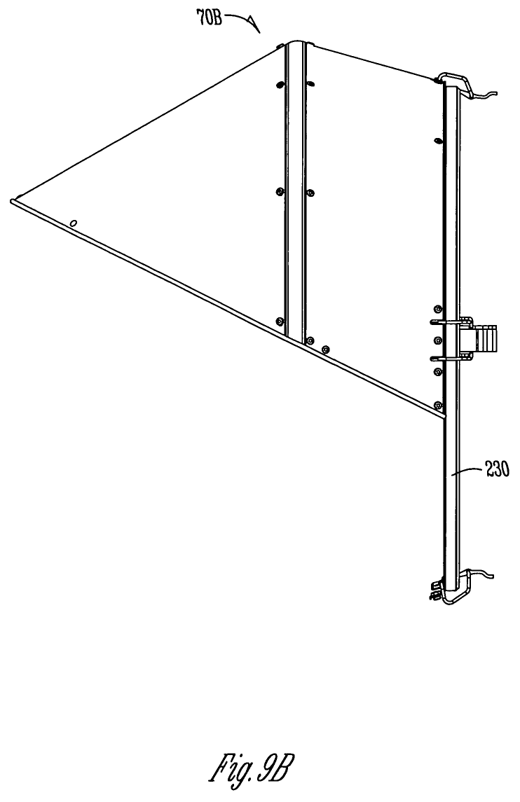

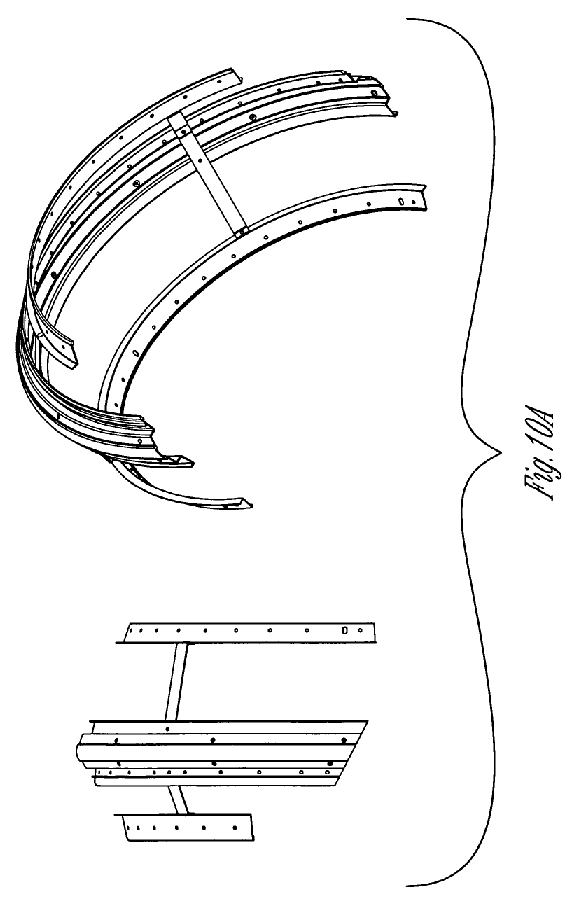

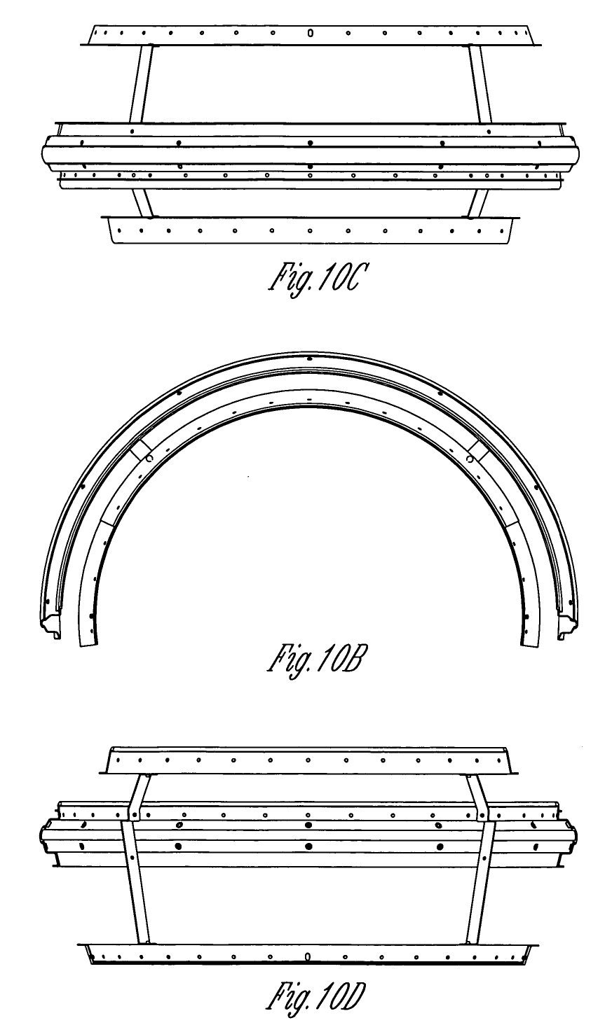

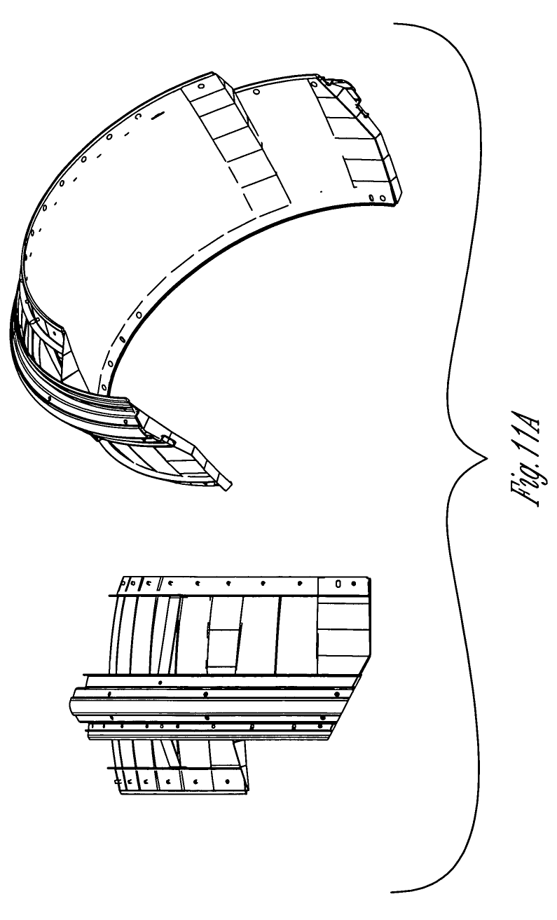

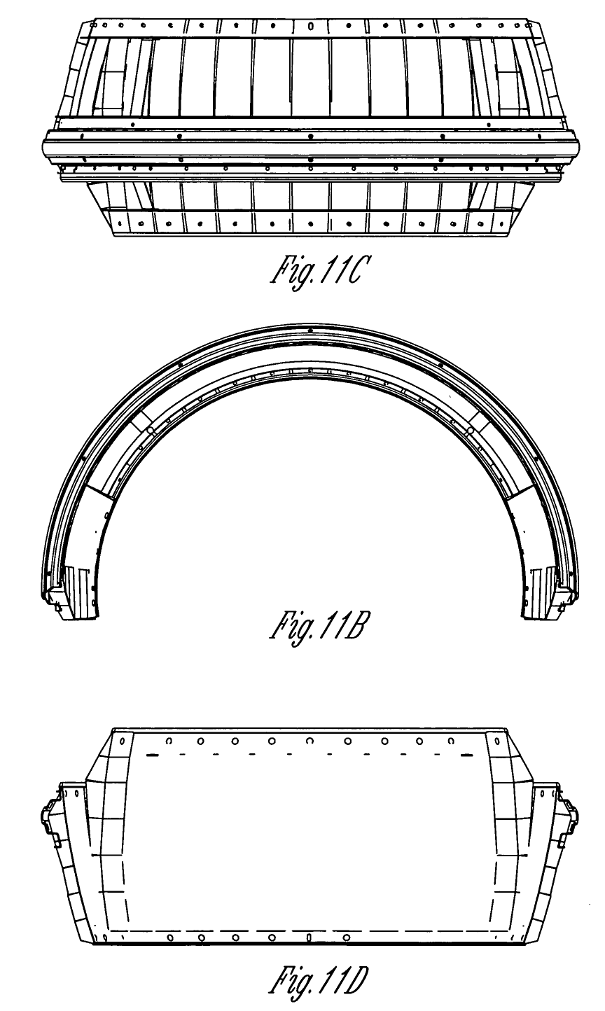

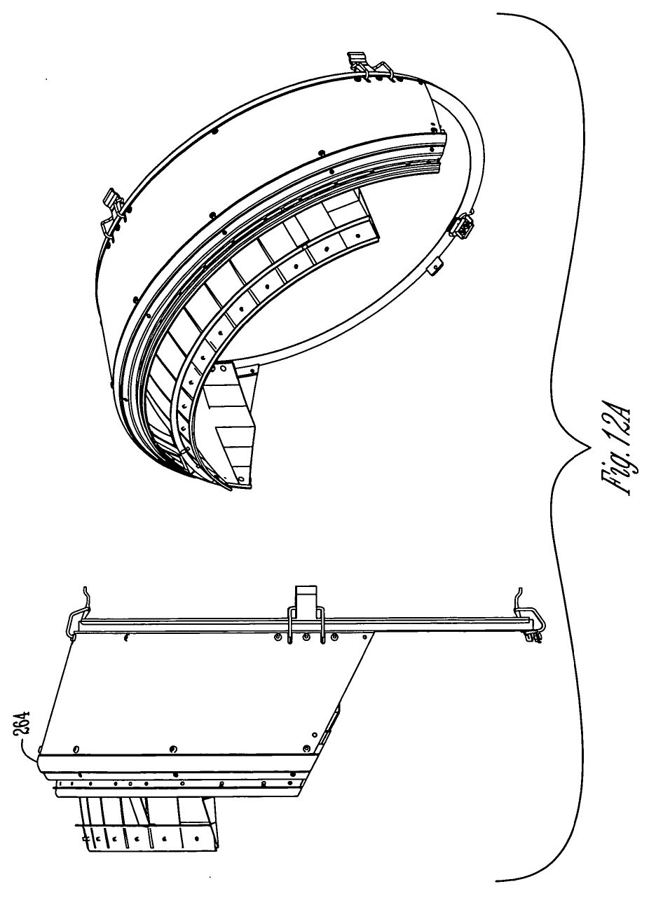

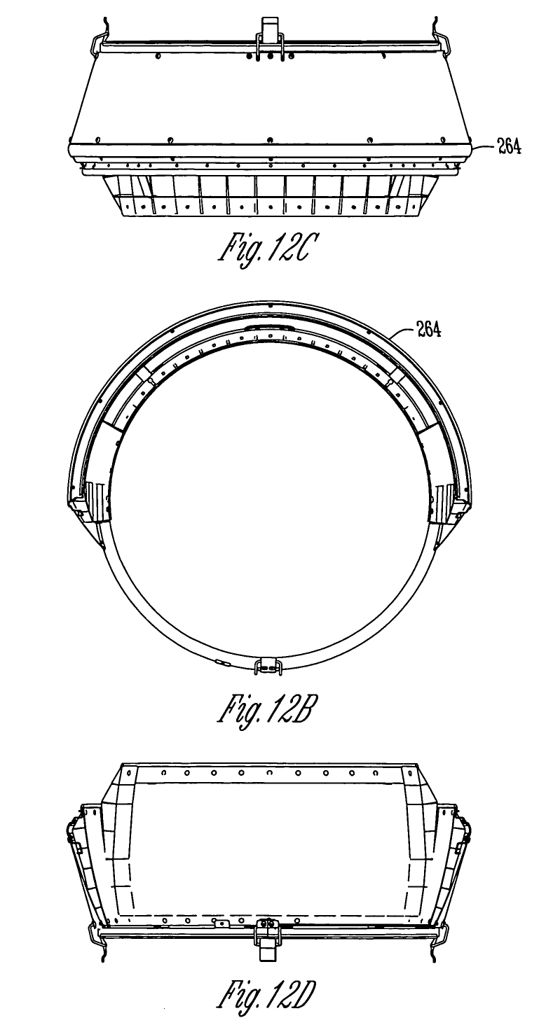

The figures illustrate one way of building a visor 70. A sheet aluminum base reflector is attached to a lens rim (FIG. 13). A framework of aluminum or metal pieces is built (FIGS. 10A-D). Reflective insert strips and pieces are mounted to that framework (FIGS. 11A-D). The framework with attached reflective inserts is attached to the base reflector (FIGS. 12A-D). A visor extension, either a short aluminum sheet piece or long piece (FIG. 15) is then attached to the sub-assembly of FIGS. 12A-D.

1. An high intensity lighting fixture for increasing useable light to a target area without an increase in energy use comprising:
a. a reflector frame mountable to the lamp cone and comprising a bowl-shaped outer surface, an inner surface including mounting structure adapted for a reflecting surface, and a primary opening over which a glass lens is mountable;
b. a visor mounted to and extending outwardly from the top of the reflector frame having an outer side and an inner side;
c. a very high total reflectance reflecting surface mountable to the inner side of the visor adapted to redirect incidence light generally downward when the fixture is in operating position relative a target area;
d. at least one louver across a portion of the reflector frame.

2. The lighting fixture of claim 1 wherein the visor inner side is adapted to support a high total reflectance reflecting surface extending outward from the reflector frame.

3. The lighting fixture of claim 1 wherein the visor reflecting surface extends forwardly of and above the lamp when the fixture is in operating position.

4. The lighting fixture of claim 1 wherein the visor reflecting surface extends about or greater than 180 d degrees around the longitudinal axis of the lamp.

5. The lighting fixture of claim 1 wherein the visor reflecting surface is of a different shape than the main portion of the reflecting surface.

6. The lighting fixture of claim 1 wherein the visor reflecting surface redirects light generally downward to the target area when the fixture is in operating position.

7. A method for high intensity lighting of a target area comprising:
a adding an extension structure to a lighting fixture, the extension structure having at least one portion that will intercept the part of the light output of the fixture;
b. designing the shape, length, and width of the extension to (i) intercept light that can cause glare or spill light, and (ii) utilize a very high total reflectance reflecting material to redirect at least some of the light to the target area.

8. The method of claim 7 further comprising selecting between shape, configuration, size, and reflecting properties for the very high total reflectance reflecting surface according to needs or desires for glare and spill control without materially diminishing amount of light to the target space and/or increasing amount of light to the target space.
